(19) United States
(12) Patent Application Publication
(10) Pub. No.: US 2007/0116307 A1
(43) Pub. Date: May 24, 2007

(54) Method of providing alternative audio/visual experiences based on user selections

(76) Inventors: Craig A. Finseth, St. Paul, MN (US); William T. Klumb, Menomonee Falls, WI (US)

Correspondence Address: John Horn, W68 N336 Palmetto Ct., Cedarburg, WI, 53012, US

(21) Appl. No.: 11/599,957

(22) Filed: Nov. 15, 2006

Related U.S. Application Data
(60) Provisional application No. 60/736,700, filed on Nov. 15, 2005.

(51) Int. Cl. H04R 5/02

(52) U.S. Cl. 381/307

(57) ABSTRACT

A method of creating a unified audio/visual experience from different source components where the selection of the sources is based on direction from an end user. A plurality of different program components that may be combined together in different ways are procured from two or more different sources of complementary program content. The program components are presented to an end user at the point of end use. Based on input from the end user specific program components are selected for combination. The selected program components are dynamically combined at the point of end use to provide a real time audio/visual experience reflecting different sources of the content and the combined program is displayed at the point of end use.

### BACKGROUND OF THE INVENTION

This application claims the benefit of U.S. Provisional patent application Ser. No. 60/736,700 filed on Nov. 15, 2005, which is incorporated herein by reference.

The present invention relates to audio/visual programming in general and more particularly to the dynamic creation of audio/visual content from different sources.

Audio/visual systems currently convey a set of unified program experiences to the user. However, the content of these experiences is fixed and controlled by whoever puts the program together. For example, an episode of a television show is created by a studio and mixed with commercials by a network for transmission to a viewer or a studio places a movie on a DVD in the same form shown in theaters. Although a DVD may contain multiple versions of a movie in different languages or even with different endings on the same media, the content of each version is determined by the DVD's creator and is static.

In both examples, the viewing experience is totally controlled by the content's creator. At best, the viewer has very limited control over the experience, that is: viewers can pause, fast forward or rewind the content, but they can't alter the substantive content.

Newer technologies such as the internet and interactive gaming allow people more control over their audio/visual experiences. They interact with the the programs as they control player characters.

Yet, in many cases, people want to experience programming without having to control it from moment to moment. This invention allows people to control their programming experience yet frees them from having to exert moment-by-moment control.

### SUMMARY OF THE INVENTION

The present invention provides a system in which contents from two or more programming sources are dynamically combined to create a new unified programming experience based on input from the user of the program given at the point of end use.

In one application, a first source provides the script of a play and a set of staging directions. A second source then provides descriptions of the actors, the costumes and the settings. The system combines the two sources to produce the play. Either of the sources could be changed to, for example, present a different play with the same setting or the same play with a different setting.

In a second application, a first source provides a television program marked with commercial insertion information. A second source provides a series of commercials. The system combines the two temporally to create a specific experience. As different viewers have different tastes, the programming provider can provide a different mix of commercials for different sets of viewers on-the-fly depending on the make up of the viewing audience.

### BRIEF DESCRIPTION OF THE DRAWINGS

FIG. 1 provides a diagrammatic view how substantive may be combined from different sources in different ways in accordance with the present invention

### DETAILED DESCRIPTION

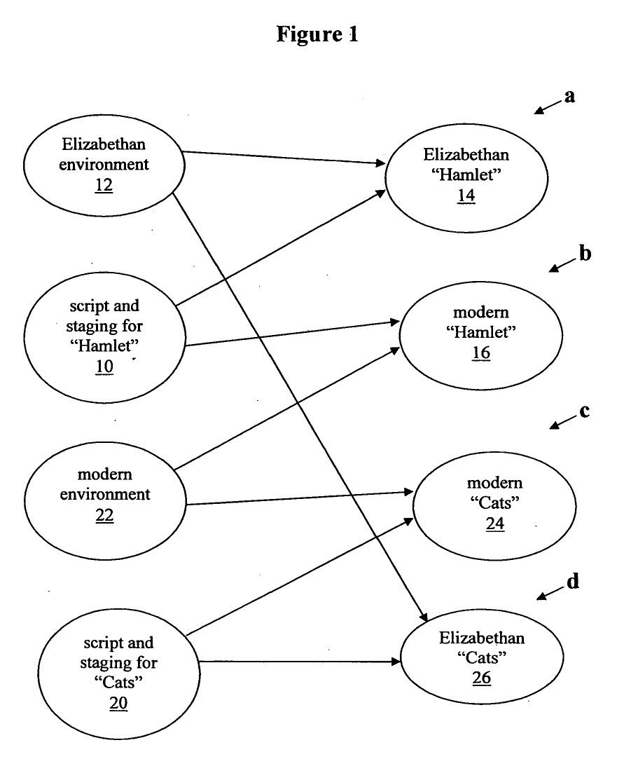

As generally shown in FIG. 1, the system enables the “mixing and matching” of complementary program content from different sources 10, 20, 12 and 22 to produce different audio/visual outputs 14, 16, 24 and 26. A user can select as a basic program either the play Hamlet 10 or the play Cats 20 and separately select the setting either an Elizabethan setting 12 or a modern setting 22. A set top box may be used to combine different complementary components of digital content by combining or streaming these components together under as directed by the program user.

In FIG. 1 at a the result is shown of selecting content for “Hamlet” 10 and an Elizabethan setting 12 which produces an Elizabethan Hamlet 14.

In FIG. 1 at b the result is shown of selecting content for “Hamlet” 10 but using a modern setting 22 which produces a modern Hamlet 16.

In FIG. 1 at c the result is shown of selecting content for “Cats” 20 and a modern setting 22 which produces a modern Cats 24.

In FIG. 1 at d the result is shown of selecting content for Cats 20 and an Elizabethan setting 12 which produces an Elizabethan Cats 26.

The sources can be broadcast television, cable television, satellite television, radio, tape, DVD, CD, hard disk, memory card, the internet, or any other source of audio/visual content.

The source material can be purchased, rented, or free; restricted in some fashion or unrestricted.

The component parts can be dialogue, staging, acting or actors, costumes, settings, music, or any other component part which may be user selected and mixed and matched with other materials to provide a unified audio/visual product. The component parts may even be complete programs in themselves. For example, a television program could be inserted within a television set in a movie.

Any of the component parts can also vary over time. For example, the costumes can start out Elizabethan, change to Victorian, and then change again to modern. These shifts can happen suddenly or continuously.

The essence of the invention is that or multiple sources are used and that they are combined at the user's direction and under the user's control at the point of end use by the end user.

### A POSSIBLE IMPLEMENTATION

It will be easier to understand this invention by discussing considerations that relate to one possible implementation or embodiment. A production of Hamlet will be used as an example.

A production starts by separating out the major components. The example will use this separation: script, actors, dialogue, staging, costumes, setting and music. It should be noted that other separations are possible. This implementation example assumes a computer-driven synthesized world such as is found in well known modern video games and some movies. ¹ Other implementations are possible.

### Script

In this example, the script is “Hamlet” by William Shakespeare. As with a movie script, it drives and organizes the entire production but does not appear directly in the final product.

### Dialogue

As with an animated movie, the dialogue provides an important part of the creative contribution. Its timing and cadence also affects the rest of the production. The dialogue can be pre-recorded as an artistic whole, sampled and played under program control, synthesized, or provided in another fashion. Within reasonable limits of timing and cadence, any given part can be voiced by more than one person and different recordings can be used as alternate content.

### Staging

Staging directs the players to the correct places and indicates how they should move and pose. It also covers how background elements and props move.

### Costumes

Users can select from a wide variety of clothing for the characters. In this implementation example, the clothing could come as part of the setting, so as to form an artistic whole. The clothing designers could use tools very similar to those used in the video game industry to make their creations.

### Setting

Users can select from a wide range of settings. And again, the set designers could use tools very similar to those used in the video game industry to create their settings.

### Music and Sound Effects

The industry has many tools to create audio tracks. The main consideration is that the product will have to adjust the music to match variations in the timing and cadence of the production. For example, one player may take slightly longer to deliver a line than another. The music will thus have to stretch to cover the longer time and the sound effect at the end will have to shift to match. Adjusting music timing on the fly is well within the capabilities of current music software and adjusting the sound effect timing is simply a matter of synchronization.

### Putting it all Together

The individual elements: script, dialogue, staging, costumes, setting, and sound are assembled into a unified whole in accordance with industry standards or conventions covering all of these as separate elements. Further, there are programming languages such as the Flash animation used on many web sites that make it easy to combine all of the elements into a unified whole.

Creating all of the pieces for a single production may well be much harder than simply producing the play. The benefits accrue when many productions are created and many of the elements: motions, props, costumes, settings, and music can be used on other productions. Also, once a production has been completed and marketed, it can be “spruced up” by releasing elements that can be updated with new content. For example, perhaps a new actor has become popular and is available to do dialog for some existing productions. Alternatively, a producer may decide to try a “old west” production of Hamlet: a small investment in settings and costumes may bring new life to an existing production.

Of course, producers normally wouldn't want to re-use items such as costumes directly since modern audiences would spot such economies quickly. However, you can start with costumes, props, and settings for one production and modify them for use in another much more economically than producing hew ones from scratch. It is possible to implement the invention with well known digital audio/visual equipment and with only minor reconfigurations. What is required is simply the work to bring it all together and, of course, the work involved in the production itself. Such work requires an investment.

1. A method for creating a unified audio/visual experience from different source components where the selection of the sources is based on direction from a user, comprising:
a) presenting a plurality of different program components supplied from two or more different sources of complementary program content that can be combined together to form an unified audio/visual output to an end user at the point of end use;
b) selecting the program components to be combined together based on input from the end user provided at the point of end use;
c) dynamically combining said program components to provide a real time audio/visual experience reflecting said different sources of the content at the point of end use; and
d) displaying the combined program contents as selected by the end user at the point of end use.

2. The method of claim 1 in which:
said program components are combined by being streamed together.

3. The method of claim 1 in which:
said program components include television shows and different sets of commercials targeted at different audiences.

4. The method of claim 1 in which:
any of the sources are from broadcast television.

5. The method of claim 1 in which:
any of the sources are from cable television.

6. The method of claim 1 in which:
any of the sources are from satellite television.

7. The method of claim 1 in which:
any of the sources are from radio.

8. The method of claim 1 in which:
any of the sources are from the internet.

9. The method of claim 1, in which:
any of the sources are from a fixed memory device.
